(19) United States
(12) Patent Application Publication
(10) Pub. No.: US 2018/0322817 A1
(43) Pub. Date: Nov. 8, 2018

(54) FABRIC COVER FOR CONCEALING A RIGID STRUCTURE

(71) Applicants: Shawn Gibson, Rogers, AR (US); Jeffrey Berman, Pickerington, OH (US)

(72) Inventors: Shawn Gibson, Rogers, AR (US); Jeffrey Berman, Pickerington, OH (US)

(21) Appl. No.: 16/028,640

(22) Filed: Jul. 6, 2018

Related U.S. Application Data
(63) Continuation-in-part of application No. 15/706,123, filed on Sep. 15, 2017.
Application No. 15/706,123 is a continuation-in-part of application No. 62/495,468, filed on Sep. 16, 2016.

(51) Int. Cl. G09F 23/00

(52) U.S. Cl. CPC G09F 23/00; G09F 15/0075

(57) ABSTRACT

A fabric cover for slidable installation onto a pole or bollard, the fabric cover consisting of a polyester body with a decorative pattern or advertisement sublimation printed onto its outer surface.

### CROSS-REFERENCE TO RELATED APPLICATIONS

This application claims the benefit of U.S. Utility patent application Ser. No. 15/706,123 filed on Sep. 15, 2017, which claims the benefit of U.S. Provisional Patent Application No. 62/495,468, entitled “EZ-Cover” and filed on Sep. 16, 2016. Such applications are hereby incorporated by reference in their entirety.

### STATEMENT REGARDING FEDERALLY SPONSORED RESEARCH OR DEVELOPMENT

Not applicable.

### BACKGROUND OF THE INVENTION

Durable structures commonly referred to as “bollards” are used in a wide variety of locations as safety precautions for protecting buildings and people from vehicle impact damage. For example, many retailers use vertical concrete bollards near the entrance of their buildings to separate sidewalks and walkways from parking and driving areas in order to protect pedestrians and storefronts from moving vehicles. Similar structures may be found in drive-thru lanes at banks, fast food restaurants, or other business locations where these drive-thru bollards are in place in order to prevent the vehicles from coming too close to the building. Finally, many cities use these types of durable structures near the entrance of park trails, bicycle paths, or even walk-only streets to prevent large vehicles from entering the pedestrian-only areas.

Because the purpose of the structures in these examples, and in many other applications not listed, is to prevent large vehicles from entering areas where they should not enter, these structures are typically made of strong materials like concrete or steel. And while many of the retailers that use these types of structure try to make the durable structures aesthetically pleasing by painting the structures with a color identical to or complimentary to the store-front or drive-thru environment, a product for covering these structures is needed. Furthermore, because these bollards are intended to keep vehicles from entering certain areas, they must be spaced apart in a way that accomplishes that goal. With this in mind, it is often necessary to place multiple bollards spaced a few feet apart in order to allow pedestrians through while blocking larger vehicles. In many applications these bollards must be used in at least groups of three, five, or even larger numbers. These structures are typically near the entrance of a store, and therefore they are generally the first thing customers see when entering the store. As existing bollards are designed, customers are greeted with nothing more than a painted concrete pole. It would be more beneficial for the companies, however, if these structures could be used for advertising to inform customers of important information as they are entering the store, pulling up to the drive through, or otherwise coming across these structures.

### BRIEF SUMMARY OF THE INVENTION

The present invention is directed to a product for covering a vertical structure and more particularly to a cover for posts or bollards used to separate pedestrian areas from other areas. In one embodiment, the present invention is directed to a removable polyester bollard cover having a generally cylindrical shape. In another embodiment, the present invention is directed to a method of manufacturing a product for covering a vertical structure. In one embodiment, the product functions as a means for concealing an otherwise unsightly structure with a decorative design and in another embodiment the product functions as a means for placing interchangeable advertisements on otherwise unused space. These and other objects, features, and advantages of the present invention will become better understood from a consideration of the following detailed description of the preferred embodiments in conjunction with the drawings as described following:

### BRIEF DESCRIPTION OF THE DRAWINGS

FIG. 1 is a perspective view of the fabric cover for concealing a rigid structure;

FIG. 2 is a front elevational view thereof;

FIG. 3 is back elevational view thereof;

FIG. 4 is a top plan view thereof;

FIG. 5 is a bottom plan view thereof;

FIG. 6 is a perspective view thereof;

FIG. 7 is a left side elevational view thereof; and

FIG. 8 is a right side elevational view thereof.

### DETAILED DESCRIPTION OF THE INVENTION

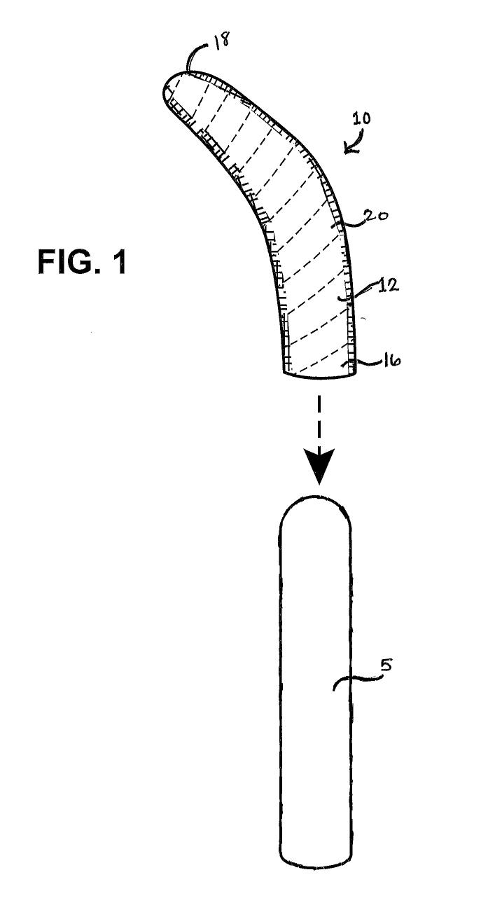

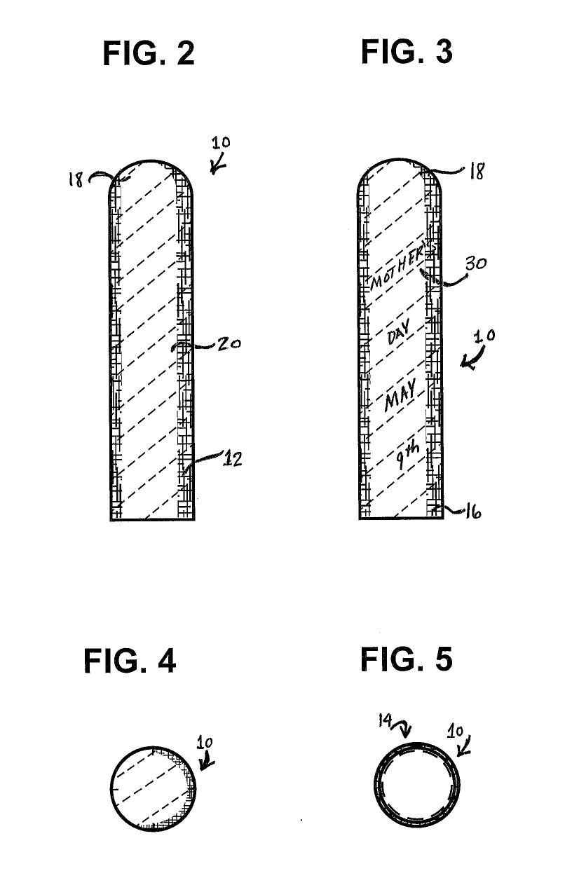

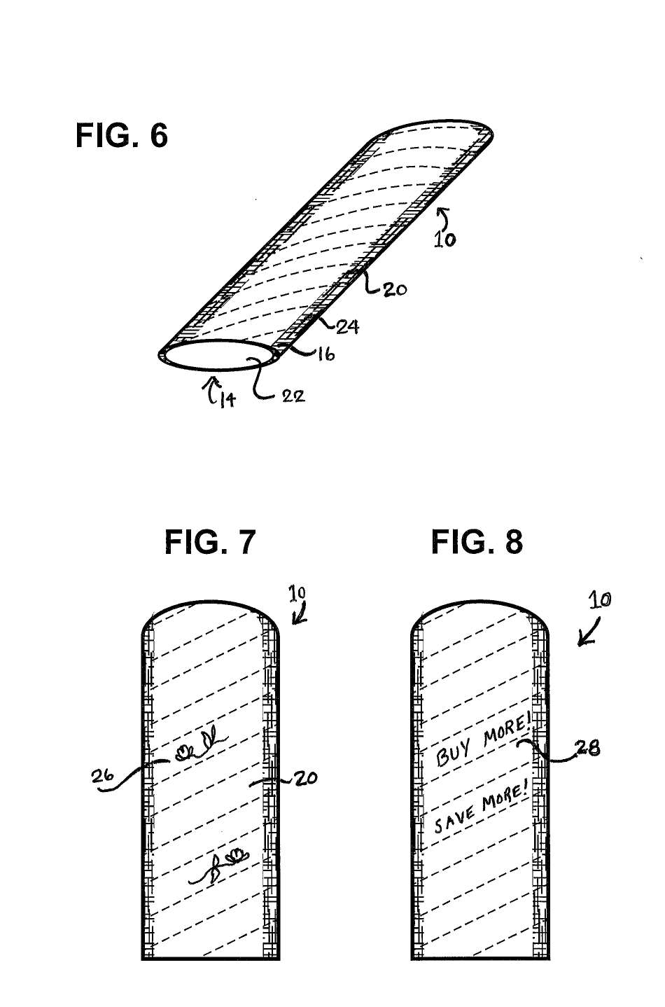

With reference to FIGS. 1-8, the cover 10 of the present invention may be described. Generally speaking, the cover 10 comprises a body 12 that is configured to be placed over a structure 5. The preferred embodiment of the cover has an elongated body 12 that gives the cover 10 a generally cylindrical shape. The body 12 has an opening 14 at the base end 16 that allows the cover to be installed onto a structure, for example a cylindrical bollard or pole, as described more completely below. In the preferred embodiment, the top end 18 is connected to the sides 20 of the body such that when the cover 10 is installed onto the structure 5, the entire structure 5 is concealed by the cover 10. However, it is understood that the top end 18 may also include an opening, thus exposing the top of the covered bollard 5 if desired. Furthermore, while the preferred embodiment is described with regard to the cover 10 having a generally cylindrical shaped body 12 (and therefore it is configured to be used with a generally cylindrical shaped structure), it is understood that the body 12 of the bollard cover 10 can take any number of shapes to correspond to various shapes of bollard structures used. For example, the body 12 may be generally spherical in shape and configured to be used with generally spherical bollard structures or may take the shape of a rectangular prism in order to be used with generally box-like structures. In any event, the shape of the body 12 of the cover 10 is configured to be substantially identical to the overall shape of the structure intended to be cover.

The body 12 of the cover 10 is made of a durable and lightweight fabric material, which allows the cover 10 to easily be added or removed from the covered structure. In the preferred embodiment, the cover 10 is made of a fabric which provides a four-way stretch capability to the cover 10, but it is understood that other stretchable fabrics may be used, such as a two-way stretch fabric. Stretchable fabrics that may be used include stretchable cottons, stretchable polyesters, and the like. Furthermore, the fabric preferably has a weight of approximately 10 gsm, but other lightweight options may also be used. The use of a durable but non-rigid fabric facilitates the easy removal and addition of the cover to rigid structures. The durable fabric allows the cover 10 to be used multiple times and in different weather conditions, but the flexible and lightweight characteristics of the fabric allow a single person to install the cover 10 on the structure without the use of any special tools. The fabric material of the cover 10 can also be machined wash should the cover become dirty during use. Furthermore, because of the non-rigid nature of the fabric, the cover 10 can be rolled, folded, or otherwise manipulated for storage purposes without damaging the cover 10. This allows the user to interchange covers 10 and store non-used covers 10 for use at a later date. Furthermore, it is preferred that the fabric have sufficient elasticity to allow the fabric cover to be easily stretched and placed over the bollard structure.

Furthermore, the manufacture of the cover 10 out of fabric material allows for the cover 10 to be manufactured in any number of shapes or sizes to fit securely on a variety of different style structures. The use of a fabric material also allows the entire cover 10 to be manufactured from a single continuous piece of fabric, which eliminates the need for any seams or other edges that could ultimately reduce the aesthetic appeal of the cover. Still, in one embodiment the cover 10 may consist of different fabric components sewn together to create the overall structure of the cover. For example, the sides of the cover may be manufactured from a single piece of fabric and the top of the cover may be made from a different piece of fabric. The top fabric may then be connected to the side fabric through sewing or some other means. The use of different fabric pieces sewn together further allows for the cover to be manufactured into a wide variety of shapes and sizes. Finally, the fabric used to create the cover 10 is preferably made from 100% recyclable materials.

The body 12 of the cover 10 of the present invention comprises an inner surface 22 and an outer surface 24. When in use, the inner surface 22 of the cover 10 is adjacent to the structure being covered and is not viewable. Because the cover 10 is positioned over and around the structure, the surface of the structure is also not viewable. Instead, the outer surface 24 of the cover 10 is the only exposed surface that can be seen. For this reason, the outer surface 24 of the cover 10 is configured to show decoration 26, advertisement 28, or other information 30 and has a layer suitable for receiving dye as discussed herein. For example, in one embodiment, shown in FIG. 7, the outer surface of the cover 10 may be printed with printed material that includes a decorative pattern 26 that provides an aesthetically pleasing cover for an otherwise unsightly pole structure. This decorative pattern may be, for example, stripes such that the installation of the cover on a structure transforms the otherwise boring structure into a candy cane. Any number of decorative patterns 26 may be used on the cover 10.

Alternatively, as shown in FIG. 8, the outer surface 24 may be printed with an aesthetic pattern or printed material that includes advertisements 28 for a particular product or business. For example, the outer surface 24 may be printed with an image 28 of new food item that is sold by a fast-food restaurant, and placed on a bollard near the drive through ordering location. This advertisement may be useful for encouraging the restaurant's consumers to purchase the new item. It is understood that other information may also be printed onto the cover, including business information, promotional information, or any information the user desires the public to see. Because the cover can quickly and easily be installed and removed from the structure, the decoration, advertisement, or information can easily be changed to correspond to the current time of year (i.e. holiday decorations can be changed) or the current promotion the business is operating (i.e. a new sale on a different item). These covers allow the business or other user to quickly install and remove advertisement and decoration without damaging the structure and without requiring the use of paint, glues or adhesives, or permanent hanging systems.

The aesthetic pattern can further consist of an image, a picture, a pictorial representation, at least one character, text, a message, a logo, a slogan, or any combination thereof.

The aesthetic pattern displayed on the outer surface of the cover is preferably printed onto the cover using a sublimation printing process. The sublimation printing process is used to apply an image to a base material, particularly polyester and polymer-coated substrates, using sublimation ink, heat, and pressure. The process uses heat to transfer the sublimation ink onto the base material. A heat press is used to transfer the dye onto the substrate material.

The ink chosen for the sublimation printing process is a heat-sensitive water-based dye, a heat-sensitive soy based dye, or a mixture of both heat-sensitive water-based and heat-sensitive soy-based dyes. The application of relatively high heat during the printing process causes a diffusion of the heat-sensitive dye, or sublimation of the dye, into the base material of the cover.

The process results in an image transfer that is generally permanent, which allows for the covers to have a permanent decoration or advertisement on its outer surface. The permanent nature of the printed outer surface prevents the printed decoration, advertisement, or other image from being removed or scratched, and the printed decoration, advertisement, or other image is not affected by water or moisture. This increases the life of the covers, which ultimately reduces the necessity for businesses to spend money on replacing advertisements and decorations. Preferably the sublimation ink or dye used for the printing process is a water-based non-solvent dye.

Now that the structure and process of manufacture of the cover has been described, the simple method by which the cover may be installed on a substrate can be described. As discussed above, the cover generally consists of a fabric body that preferably has an opening at its base. To install the cover on a bollard or other structure, the cover is removed from its packaging and the open end of the cover is placed over the structure to be covered. The cover is then slid down the entire length of the structure so that the entire structure is covered. In some cases it may be necessary to slightly stretch the open base in order for the cover to fit around the structure. The elasticity of the polyester fabric used for the cover helps facilitate this action. Furthermore, the elasticity of the polyester fabric works to hold the cover in place on the structure, as once the cover is placed over or around the structure, the elastic nature of the fabric contracts onto the structure, providing for a tight fit around the structure. This tight fit allows the cover to remain in place until an upward force is used to slide the cover off of the structure. Once the cover is removed from the structure, it can be folded or rolled and placed in storage and a separate cover can be installed on the structure.

The present invention has been described with reference to certain preferred and alternative embodiments that are intended to be exemplary only and not limiting to the full scope of the present invention.

We claim:

1. A cover for concealing a rigid structure, said cover comprising:
a body consisting of a single piece of stretchable fabric selected from a group consisting of a two-way stretch material, a four-way stretch material, a stretch polyester, and a stretch cotton, said body further comprising
an outer surface having a heat-sublimating transfer ink layer configured to receive a heat-sublimated dye to form an image visible on said outer surface;
an interior surface forming an internal compartment having an open base for slidably receiving the rigid structure; and
wherein said cover is configured to display said image on said outer surface when the rigid structure is slidably inserted into said internal compartment.

2. The cover of claim 1, wherein said heat-sublimated image comprises printed material selected from the group consisting of advertisements and decorative patterns.

3. The cover of claim 1, wherein said body comprises a generally cylindrical shape.

4. The cover of claim 1, wherein both said body and the rigid structure comprise a substantially identical shape.

5. The cover of claim 1, said heat-sublimated dye selected from the group consisting of heat-sensitive water-based dye, heat-sensitive soy-based dye, and a mixture of heat-sensitive water-based dye and heat-sensitive soy-based dye.

6. A cover for concealing a bollard, said cover comprising:
an elongated hollow body consisting of a single sheet of stretchable fabric selected from a group consisting of a two-way stretch material, a four-way stretch material, a stretch polyester, and a stretch cotton, said elongated hollow body further comprising
an open base;
an outer surface having a ink layer configured to receive a dye forming an image, said image comprising an aesthetic pattern selected from the group consisting of an image, a picture, a pictorial representation, at least one character, text, a message, a logo, a slogan, and any combination thereof;
wherein said elongated hollow body is configured to be slidably placed over an elongated structure such that elongated hollow body conceals the elongated structure and said image on said outer surface of said elongated hollow body is displayed.

7. The cover of claim 6, said heat-sublimated dye selected from the group consisting of heat-sensitive water-based dye, heat-sensitive soy-based dye, and a mixture of heat-sensitive water-based dye and heat-sensitive soy-based dye.

8. A flexible removable cover for concealing a rigid structure, the removable cover comprising:
an elongated cylindrical body, consisting of a single piece of stretchable fabric selected from a group consisting of a two-way stretch material, a four-way stretch material, a stretch polyester, and a stretch cotton, said elongated cylindrical body further comprising
an outer surface having a heat transfer ink layer configured to receive a dye to form at least one aesthetic pattern, said at least one aesthetic pattern selected from the group consisting of an image, a picture, a pictorial representation, at least one character, text, a message, a logo, a slogan, and any combination thereof; and
an open base.

9. The cover of claim 8, said heat-sublimated dye selected from the group consisting of heat-sensitive water-based dye, heat-sensitive soy-based dye, and a mixture of heat-sensitive water-based dye and heat-sensitive soy-based dye.
